(19) United States
(12) Patent Application Publication
(10) Pub. No.: US 2021/0219500 A1
(43) Pub. Date: Jul. 22, 2021

(54) Plant Holder and Method of Arranging Plants

(71) Applicant: Ching Yann Meng, Naperville, IL (US)

(72) Inventor: Ching Yann Meng, Naperville, IL (US)

(21) Appl. No.: 16/749,747

(22) Filed: Jan. 22, 2020

(51) Int. Cl. A01G 9/02

(52) U.S. Cl. CPC A01G 9/028

(57) ABSTRACT

A plant holder and method is disclosed. The plant holder has a connecting surface and a plurality of receptacles. The plant holder is configured to be received in a first pot. Each of the plurality of receptacles is configured to receive a plant-containing second pot. The plurality of receptacles interrupt the connecting surface. The plurality of receptacles each have a receptacle bottom wall and a receptacle sidewall defining a partially enclosed receptacle interior space. The receptacle bottom walls support the plant holder on a first bottom wall of the first pot within a first interior of the first pot. The connecting surface has a peripheral edge configured to face the first sidewall of the first pot.

### FIELD OF THE INVENTION

This invention relates in general to plant holders.

### BACKGROUND OF THE INVENTION

A plant can be located within a pot for deploying the plant in a variety of locations, including indoor locations. However, arranging multiple plants in pots can be time-consuming and labor intensive. Further, arranging multiple plants may require labor with skills to properly select, place, and space plants to achieve a desired appearance or arrangement.

The present inventor recognized the need for a device that would increase the ease of staging and arranging multiple plants within a pot. The present inventor recognized the need for a device that would reduce the time and complexity in arranging plants within a pot. The present inventor recognized the need for a device that would assist in properly placing and spacing plants relative to other plants in an arrangement of plants. The present inventor recognized the need for a device that would enable different types of plants to easily be staged for deployment in the same pot. The present inventor recognize the need for a device that would enable florists and horticulturist to easily stage arrangements of plants, including flowering plants.

### SUMMARY OF THE INVENTION

A plant holder is disclosed. The plant holder has a connecting surface and a plurality of receptacles. The plant holder is configured to be received in a first pot. Each of the plurality of receptacles is configured to receive a plant-containing second pot. The plurality of receptacles interrupt the connecting surface. The plurality of receptacles each have a receptacle bottom wall and a receptacle sidewall defining a partially enclosed receptacle interior space. The receptacle bottom walls supports the plant holder on a first bottom wall of the first pot within a first interior of the first pot. The connecting surface has a peripheral edge configured to face the first sidewall of the first pot.

A method of supporting a plurality of plant types within a first pot is disclosed. A plant holder is provided. A second pot is placed in a first receptacle of the plurality of receptacles of the plant holder, wherein the second pot has a first type of plant. A third pot is placed in a second receptacle of the plurality of receptacles of the plant holder, wherein the third pot has a second type of plant that is different from the first type of plant. The plant holder is placed within the first pot. In some embodiments, fill material is added to the top of the connecting surface to conceal the plant holder within the first pot.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a perspective transparent view of a plant holder of the invention.

FIG. 2 is a top perspective view of the plant holder of FIG. 1.

FIG. 3 is a perspective transparent view of the plant holder of FIG. 1 deployed in a pot.

FIG. 4 is a perspective transparent view of the plant holder of FIG. 1 having pots in some of the receptacles.

FIG. 5 is a perspective view of the plant holder deployed in a pot holding plants.

FIG. 6 is a perspective transparent view of the plant holder deployed in a pot holding plants.

FIG. 7 is a perspective view of a second embodiment plant holder of the invention.

FIG. 8 is a top view of a third embodiment plant holder of the invention.

FIG. 9 is a top view of a fourth embodiment plant holder of the invention.

FIG. 10 is a top view of a fifth embodiment plant holder of the invention.

FIG. 11 is a top view of a sixth embodiment plant holder of the invention.

FIG. 12 is a top view of a seventh embodiment plant holder of the invention.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, this description describes and the drawings show specific embodiments of the invention with the understanding that the present disclosure is to be considered as an exemplification of the principles of the invention and is not intended to limit the invention to the specific embodiments illustrated.

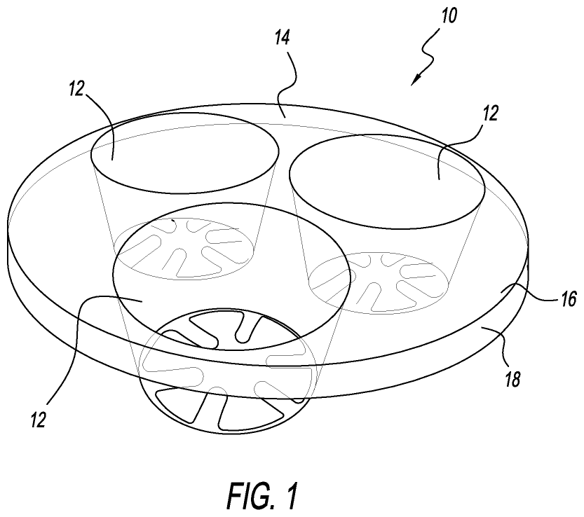

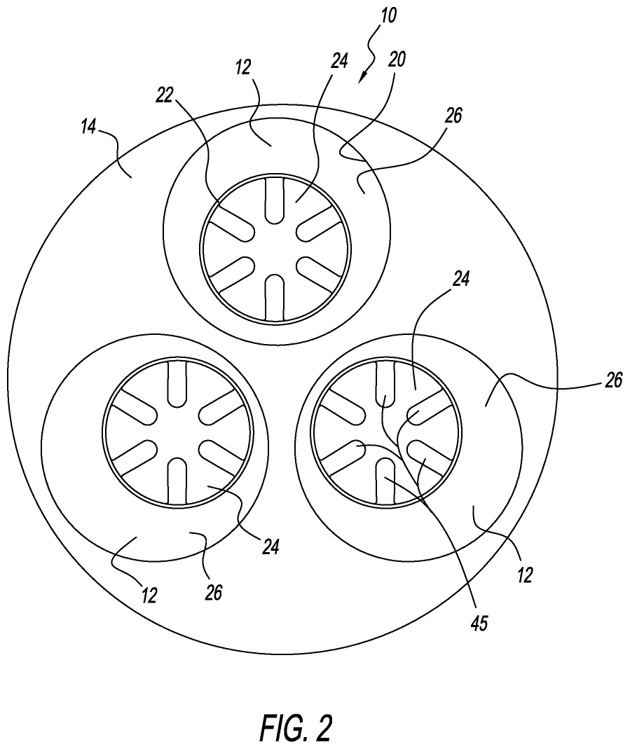

FIG. 1 shows an embodiment of the plant holder 10. The plant holder comprises a plurality of plant holding receptacles 12. In the embodiment of FIG. 1, three plant holding receptacles are shown. The plant holding receptacles 12 are recessed from a connecting or upper surface 14 of the holder 10.

At an outer perimeter or peripheral edge 16 of the upper surface 14, is a peripheral lip 18 that extends downward from the upper surface. In some embodiments the peripheral lip is cylindrical or curved. In some embodiment, the peripheral lip is a side wall, which may extend further downward than shown in the drawings. In embodiments, a peripheral lip does not extend downward from the upper surface and the upper surface terminates at the peripheral edge 16.

In some embodiments, the size of the receptacle 12 at a top edge 20, such as at or adjacent the upper surface 14, is greater than the size of the receptacle at a bottom edge 22 where a sidewall(s) 26 of the receptacle intersects the bottom wall 24 of the receptacle. Therefore, the sidewall(s) 26 can taper inward as the sidewall extends down to meet the bottom wall. The tapered sidewall or truncated cone shape feature can enable easy of placing a plant within the receptacle while also providing a friction fit further down due to the narrowing of the cross-sectional size of the receptacle along the vertical extent of the receptacle in the downward direction toward the bottom wall 24.

In some embodiments the receptacles comprise a cross-sectional size or diameter of between and including two and four inches, including in some embodiments, a 2 inch, 2.5 inch, 3 inch, 3.5 inch, and/or 4 inch cross-sectional size or diameters. While the receptacles are shown in circular cross-section other cross-sectional shapes are possible, such as quadrilateral, square, triangle, rectangle, oval shapes.

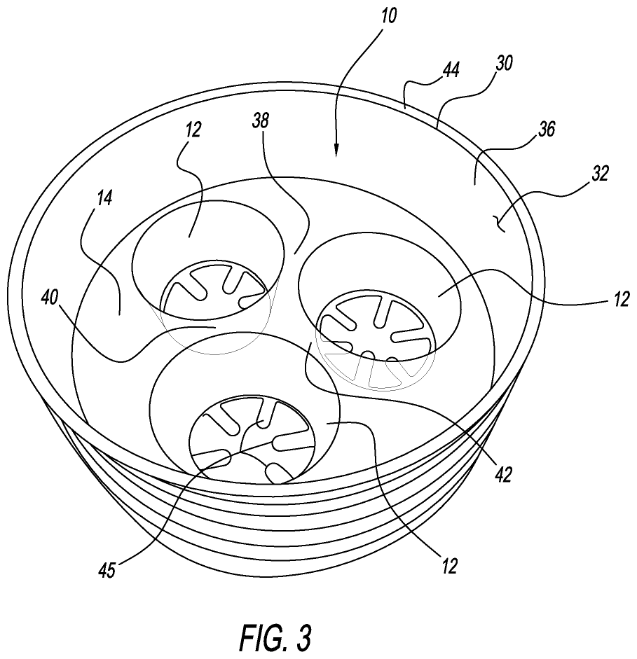

FIG. 3 shows the plant holder 10 deployed in a pot 30. The interior space 32 of the pot 30 is large enough to receive the holder 10. While the pot has a circular cross-section shown in the drawings, the pot may have other cross-sectional shapes, such as quadrilateral, square, rectangle, triangle, oval shapes. The holder 10, peripheral lip 18, and/or the peripheral edge 16 of the holder can be shaped to match the cross-section shape of the pot where it is to be deployed. Where the pot interior and holder comprises multiple sides, the peripheral lip 18 may comprises a plurality of peripheral lips bounding the sides of holder. The interior space of the pot 30 is defined at least by the bottom wall and the sidewall 36 of the pot 30. The holder 10 is supported by contact between the bottom walls 24 of the receptacles 12 against the bottom wall 34 of the pot 30.

The peripheral lip 18 and/or the peripheral edge 16 is in contact or is adjacent to the sidewall 36 of the pot 30. This provides lateral stability to the holder 10 relative to the pot 30 by providing a surface to prevent or substantially limit lateral movement of the holder relative to the pot. In some embodiments, the holder is friction fitted into the pot 30. In one process, the holder 10 can be placed in or removed from the pot by grabbing with a user's hand the side walls of adjacent receptacles 12, such as between the top interspaces 38, 40, 42 of the top 14.

The upper surface 14 of the holder 10 is below the top edge 44 of the pot 30. In some embodiments, the height of the holder 10 is half or less of the height of the pot 30 or its sidewall 36. In some embodiments, the height of the holder 10 is three-fourths or less than the height of the pot 30 or its sidewall 36.

In some embodiments, the bottom 24 of the receptacles comprises raised protrusions 45. The protrusions may extend radially from or toward the sidewall 26. The protrusions may provide a gripping surface to resist twisting of a pot located within the receptacle.

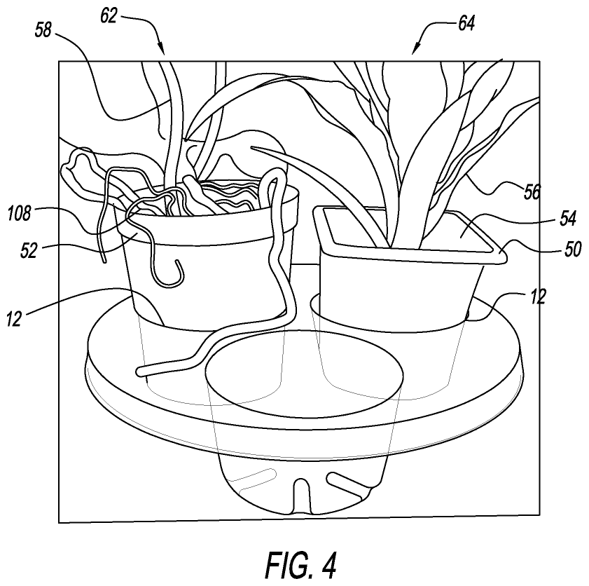

FIG. 4 shows two pots 50, 52 located in two of the three receptacles 12. The pots 50, 52 are smaller than pot 30. Pot 50 has a square cross-section. Pot 52 has a circular cross-section. The pots 50, 52 can comprise other cross-sectional shapes, such as quadrilateral, rectangle, triangle, or oval shapes. The cross-sectional shape(s) of the receptacles can be made to match the anticipated cross-sectional shapes of the pots to be received in the receptacles. Therefore, the receptacles may have multiple sidewalls defining the interior side boundaries of the interior space of each of the receptacles

The sidewall 26 of the receptacles hold the pots 50, 52 is an upright orientation. The sidewalls 26 of the receptacle support the pots 50, 52 against lateral or substantial lateral movement. The pots 50, 52 each comprise one or more plants 56, 58, and such plants can include flowering plants. In addition, each pot comprises soil 54 and/or other supportive material. The holder 10 allows different groupings or arrangements of plants 62, 64 to be placed in the same larger pot 30.

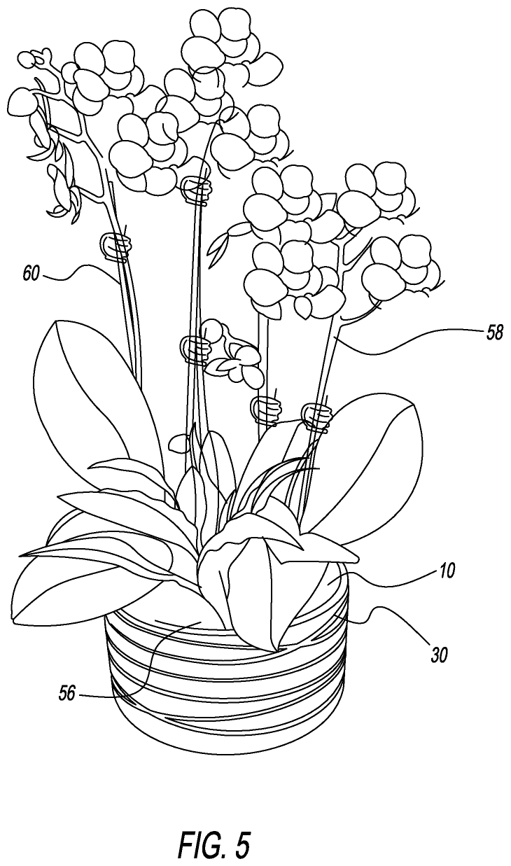

FIG. 5 shows the holder 10 deployed in the pot 30, where each of the receptacles 12 are filled with a smaller pot 50, 52 (not labeled for last receptacle) containing one or more plants 56, 58, 60.

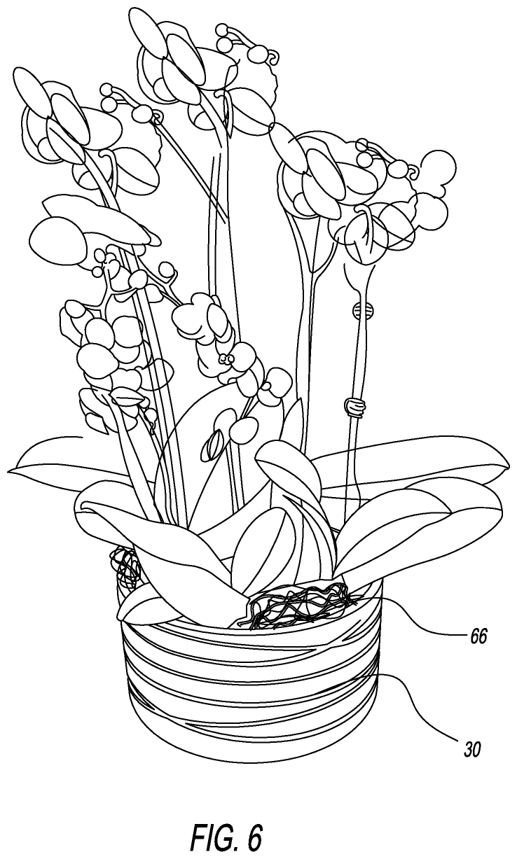

FIG. 6 shows that fill material 66, such as moss, may be placed over the holder, including on the upper surface 14 of the holder to hide the holder 10 from view and to create a pleasing view of the plants contained in the larger pot 30. Other fill material may be used, such as bark or gravel.

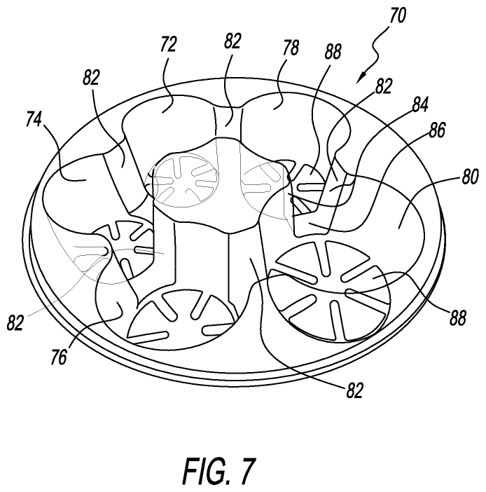

FIG. 7 show a second embodiment plant holder 70. The holder is similar to holder 10 except that holder 70 has five receptacles 72, 74, 76, 78, 80. Further holder 70 has between spaces 82 between adjacent receptacles. The between spaces are bounded by opposite side walls 84 and a floor 86. The floor 86 of the open spaces may be raise compared to the height of the floor 88 of the receptacles.

The five receptacles are not all the same cross-sectional size, such as not the same diameter. In some embodiments, receptacles 72, 74 are the same size and receptacles 76, 78 are the same size. In some embodiments all the receptacles are the same size. In some embodiments, some but not all of the receptacles are the same size. In some embodiment, all the receptacles have different cross-sectional sizes.

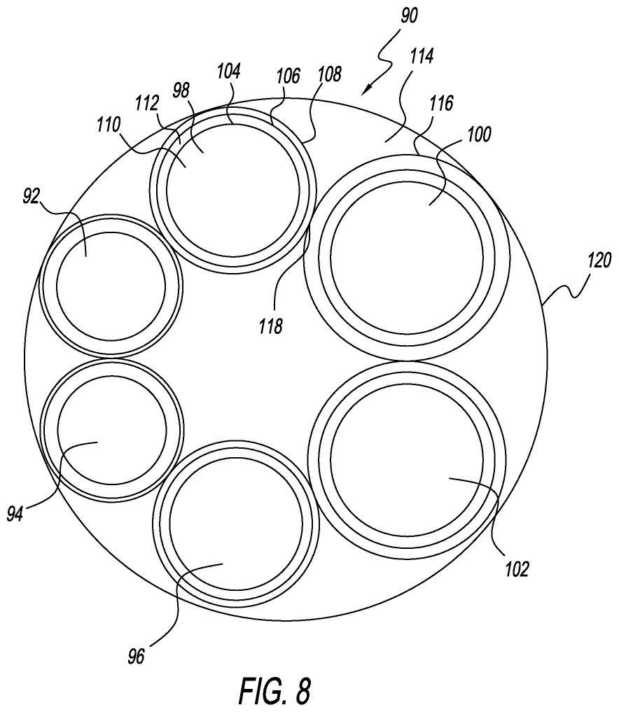

FIG. 8 shows a third embodiment plant holder 90. The holder 90 is similar to holder 70 except that the receptacles are spaced closer together. At each receptacle is shown three circles 104, 106, 108. Circle 104 represents the edge where the bottom wall 110 meets the sidewall 112 of the receptacle. Circle 106 represents the edge where the side wall 112 of the receptacle meets the upper surface 114 of the holder 90. Circle 108 represents the top lip 108 of the small pot, such as pot 52. Since the small pot 52 has an expanding diameter along its vertical extent from the bottom to the top, the top lip may be wider than the diameter at the top edge 106 of the receptacle. Therefore, while the receptacles might be spaced apart, the top portion or top lips 108, 116 of adjacent pots might touch or overlap 118. Further, a portion of the top lips 108, 116 may align with the perimeter edge 120 of the top 114 of the holder 90.

The holder allows users to stage multiple plants in a group within the holder for current or later placement within a larger pot, such as pot 30. The smaller pots, such as 50, 52, can be staged within the receptacles of the holder so as to create a plant or flower arrangement of multiple different type of plants or flowers. By using multiple holders, a user can create a variety of plant arrangements which are staged for later deployment in a larger pot. After the plant arrangements are created using the holder, the plants within each holder can be maintenanced, such as by watering, until the need to transport or sell the arrangements, at which point, or at any earlier point, the holder can be placed in a larger pot, such as pot 30, and then delivered to the customer or retailer. The holder greatly reduces labor costs and complexities in creating arrangements of plants, including arrangements of different types of plants within a single larger pot.

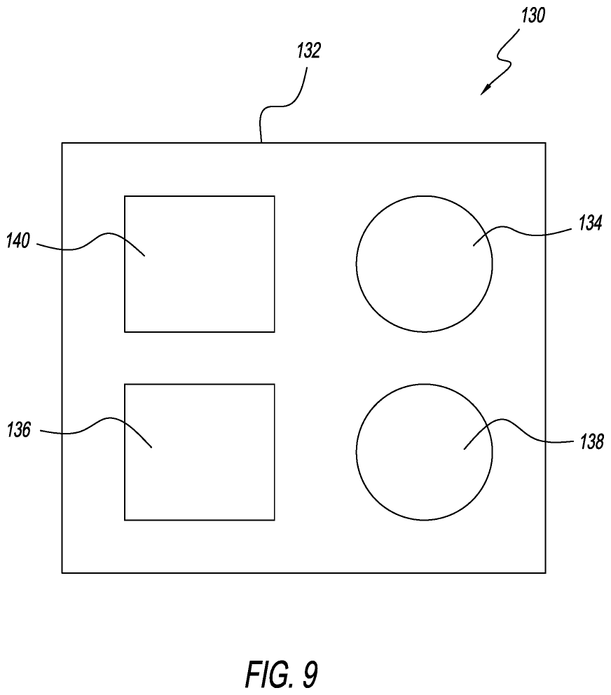

FIG. 9 shows a top view of a fourth embodiment holder 130, which is similar to holder 10, except the perimeter 132 is quadrilateral (e.g. square) shaped and the cross-sectional shapes of some of the receptacles are quadrilateral rather than circular. The holder 130 comprise plant holding receptacles 134, 136, 138, 140 of different cross-sectional shapes. Receptacles 134, 138 have a circular shaped cross-section, as in the case of receptacles 12. Receptacles 136, 140 have a square shaped cross-section. The receptacles may have sidewalls that taper inward from the top to the bottom, as is the case regarding receptacles 12.

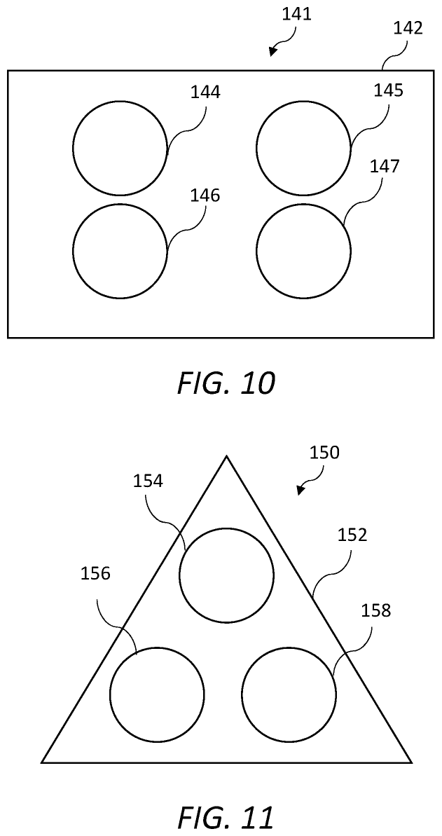

FIG. 10 shows a top view of a fifth embodiment holder 141, which is similar to holder 10, except the perimeter 142 is rectangle shaped. The holder 141 comprise plant holding receptacles 144, 145, 146, 148. In some embodiments, the receptacles are the same as receptacles 12. The receptacles are shown with a circular cross-section shape, but the receptacles can be provided in other shapes and the receptacle shapes can be a mixed variety of shapes such as shown in FIG. 9. The receptacles may have sidewalls that taper inward from the top to the bottom, as is the case regarding receptacles 12.

FIG. 11 shows a top view of a sixth embodiment holder 150, which is similar to holder 10, except the perimeter 152 is triangle shaped. The holder 150 comprises plant holding receptacles 154, 156, 158. In some embodiments, the receptacles are the same as receptacles 12. The receptacles are shown with a circular cross-section shape, but the receptacles can be provided in other shapes and the receptacle shapes can be a mixed variety of shapes such as shown in FIG. 9. The receptacles may have sidewalls that taper inward from the top to the bottom, as is the case regarding receptacles 12.

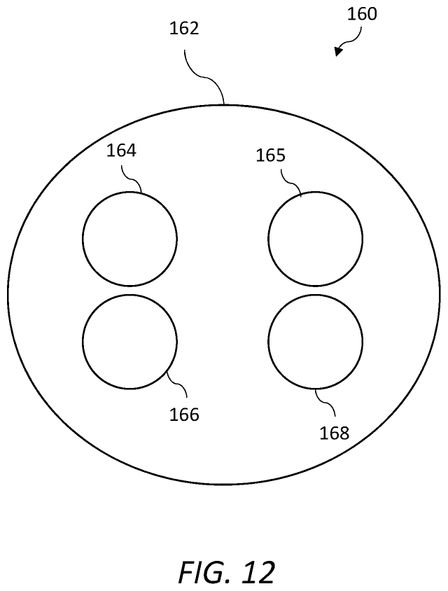

FIG. 12 shows a top view of a seventh embodiment holder 160, which is similar to holder 10, except the perimeter 162 is oval shaped. The holder 160 comprises plant holding receptacles 164, 165, 166, and 168. In some embodiments, the receptacles are the same as receptacles 12. The receptacles are shown with a circular cross-section shape, but the receptacles can be provided in other shapes and the receptacle shapes can be a mixed variety of shapes such as shown in FIG. 9. The receptacles may have sidewalls that taper inward from the top to the bottom, as is the case regarding receptacles 12.

While the holder 10, 70 are shown transparently in some of the drawings, in some embodiments, the holders 10, 70 are opaque or translucent rather than transparent.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. Further, steps could be added or removed from the processes described. Therefore, other embodiments and implementations are within the scope of the invention.

The invention claimed is:

1. A plant holder apparatus, comprising:
a first pot comprising a first bottom wall and a first sidewall defining a first interior space; and,
a plant holder comprising
a connecting surface,
a plurality of receptacles each configured to receive a second pot that is smaller than the first pot, the plurality of receptacles interrupting the connecting surface, the plurality of receptacles each comprising a receptacle bottom wall and a receptacle sidewall defining a partially enclosed receptacle interior space, the receptacle bottom walls supporting the plant holder on the first bottom wall within the first interior, and,
a peripheral side extending from a perimeter of the connecting surface and configured to face the first sidewall.

2. The apparatus of claim 1, wherein the peripheral side is a peripheral lip that is transverse to the connecting surface, and the peripheral lip is in contact with the first sidewall.

3. The apparatus of claim 1, wherein at least one of the plurality of receptacles comprises a circular cross-section.

4. The apparatus of claim 1, wherein at least one of the plurality of receptacles comprises a truncated conical profile.

5. The apparatus of claim 1, wherein the at least one of the plurality of receptacles comprises a quadrilateral cross-section.

6. The apparatus of claim 1, wherein the connecting surface is an upper surface and the plurality of receptacles extend recessed from the upper surface.

7. The apparatus of claim 1, wherein each of the plurality of receptacles comprises a top diameter at a top of the receptacle that is larger than a bottom diameter at a bottom of the receptacle at or adjacent the bottom wall.

8. The apparatus of claim 1, wherein at least one receptacle of the plurality of receptacles comprises a different cross-sectional size than a cross-sectional size of at least one other receptacle of the plurality of receptacles.

9. A plant holder for a first plant pot, comprising:
a connecting surface,
a plurality of receptacles each configured to receive a plant-containing second pot, the plurality of receptacles interrupting the connecting surface, the plurality of receptacles each comprising a receptacle bottom wall and a receptacle sidewall defining a partially enclosed receptacle interior space, the receptacle bottom walls supporting the plant holder within the first pot, and,
the connecting surface comprising a peripheral edge configured to face the first sidewall of the first pot.

10. The holder of claim 9, wherein the peripheral edge is a peripheral lip that is transverse to the connecting surface.

11. The holder of claim 9, wherein at least one of the plurality of receptacles comprises a circular cross-section.

12. The holder of claim 9, wherein at least one of the plurality of receptacles comprises a truncated conical profile.

13. The holder of claim 9, wherein the at least one of the plurality of receptacles comprises a quadrilateral cross-section.

14. The holder of claim 9, wherein the connecting surface is an upper surface and the plurality of receptacles extend recessed from the upper surface.

15. The holder of claim 9, wherein each of the plurality of receptacles comprises a top diameter at a top of the receptacle that is larger than a bottom diameter at a bottom of the receptacle at or adjacent the bottom wall.

16. The holder of claim 9, wherein at least one receptacle of the plurality of receptacles comprises a different cross-sectional size than a cross-sectional size of at least one other receptacle of the plurality of receptacles.

17. The holder of claim 16, wherein the different cross-sectional size and the cross-sectional size of at least one other receptacle of the plurality of receptacles are each diameters.

18. A method of supporting a plurality of plant types within a first pot, comprising the steps of:
providing a plant holder comprises a connecting surface and a plurality of receptacles, and a peripheral sidewall, the plurality of receptacles each configured to receive a second pot that is smaller than the first pot, the plurality of receptacles interrupting the connecting surface, the plurality of receptacles each comprising a receptacle bottom wall and a receptacle sidewall defining a partially enclosed receptacle interior space, and, the peripheral side extending from a perimeter of the connecting surface and faces the first sidewall;
placing a second pot in a first receptacle of the plurality of receptacles, wherein the second pot comprise a first type of plant.
placing a third pot in a second receptacle of the plurality of receptacles wherein the third pot comprises a second type of plant that is different from the first type of plant; and,
placing the plant holder within the first pot so that the peripheral sidewall faces an interior side wall of the first pot and the receptacle bottom walls support the holder on a bottom wall of the first pot.

19. The method of claim 18, comprising the step of adding fill material on the top of the connecting surface to conceal the plant holder within the first pot.

20. The method of claim 18, comprising the step of placing a fourth pot in a third receptacle of the plurality of receptacles wherein the fourth pot comprises a third type of plant that is different from the first and second types of plants.
